(19) United States
(12) Patent Application Publication
(10) Pub. No.: US 2015/0128500 A1
(43) Pub. Date: May 14, 2015

(54) SEGMENTED INVERTING COVER PLATE APPARATUS FOR UNDERFLOOR VEHICLE LIFTING JACK

(71) Applicant: QINGDAO SIFANG ROLLING STOCK RESEARCH INSTITUTE CO., LTD., QINGDAO, SHANDONG (CN)

(72) Inventors: Hui Ding, Qingdao (CN); Xiaodong Xing, Qingdao (CN); Lipeng Shao, Qingdao (CN); Minghai Wang, Qingdao (CN)

(73) Assignee: QINGDAO SIGFANG ROLLING STOCK RESEACH INSTITUTE CO., LTD, Qingdao (CN)

(21) Appl. No.: 14/401,502

(22) PCT Filed: May 13, 2013
(86) PCT No.: PCT/CN2013/075550

§ 371 Date: Nov. 14, 2014

(30) Foreign Application Priority Data
Jun. 13, 2012 (CN) 201210192426.2

(51) Int. Cl. E02D 29/14; B66F 7/28

(52) U.S. Cl. CPC E02D 29/14; B66F 7/28
USPC 49/363

(57) ABSTRACT

Disclosed is a segmented inverting cover plate apparatus for an underfloor vehicle lifting jack. The apparatus comprises a cover plate, the cover plate being of a segmented structure, comprising a first movable cover plate (4) and a second movable cover plate (6), wherein the first movable cover plate (4) and the second movable cover plate (6) are hinged by means of a pin shaft. An anti-inversion block (5) is provided directly below the pin shaft, the anti-inversion block (5) being connected to the first movable cover plate (4) by means of the pin shaft. A guide wheel (7) is provided below the end of the second movable cover plate (6) away from the first movable cover plate (4). An inverting arm (3) is provided below the first movable cover plate (4), one end of the inverting arm (3) is connected to the anti-inversion block (5) by means of a bearing, the other end is connected to a powered push rod (1) by means of the pin shaft and an oil-containing bearing, and the powered push rod (1) is installed on a powered push rod mounting seat (2). The advantages of the present invention are: 1. in the course of overhauling, the lifting of a jacking element does not need to open the inverting cover plate; 2. after being closed, the first movable cover plate will not occupy the limited overhauling space, reducing safety risks for personnel performing the overhaul; and 3. various models of vehicle lifting element can be used.

### FIELD OF THE INVENTION

The invention relates to railway locomotive repair equipment, in particular to a cover plate apparatus for underfloor vehicle lifting jack used for examining and repairing railway vehicles.

### BACKGROUND OF THE INVENTION

The underfloor vehicle lifting jack is used for examination and repair of motor train units, high-speed trains, high-power locomotives or urban rail vehicles which are intact and not dismantled, including replacement of bogies for railway vehicles, examination and repair and replacement of electric installations at the bottom and top of the vehicle bodies, etc. With large-scale use of motor train units and high-speed trains in China, the underfloor vehicle lifting jack for motor train units plays an important role in high-level examination and repair of trains. For unwheeling of a motor train unit, firstly the entire train is synchronously lifted to a certain height by a bogie lift unit and the bogie is disassembled, then the railway carriage is propped up by a vehicle body lift unit.

In the process of unwheeling, both the lift pillar and the propping head part of the vehicle body lift unit elevate above the soil, hence the cover plate at ground level is provided with corresponding openings, which are not only inconvenient for examination and repair, but also bring hidden danger for personal safety of maintainers. Frequently, an inverting cover plate apparatus is used in order to block off these openings without influencing stretching and retraction of the vehicle body lift pillar. A conventional inverting cover plate has the following two structures: (1) the inverting cover plate is directly jacked up by the vehicle body lift unit, and the guide wheel on the inverting cover plate jacked up rolls along the lift pillar; this type of cover plate is applicable in the case that the propping head is basically parallel and level to the lift pillar, but not applicable in the case that the propping head is comparatively long. (2) a per pale inverting cover plate, the inverting cover plate of this structure takes up a large space, thus reducing the space for examination and repair, which is inconvenient for examination and repair of vehicles lifted.

### SUMMARY OF THE INVENTION

In allusion to above-mentioned problems of the existing inverting cover plate for underfloor vehicle lifting jack, the invention provides an inverting cover plate apparatus for underfloor vehicle lifting jack which is reliable and practical in structure and safe and convenient in use.

The technical scheme of the invention is as below: a segmented inverting cover plate apparatus for an underfloor vehicle lifting jack, comprising a cover plate, wherein the cover plate being of a segmented structure, comprising a first movable cover plate and a second movable cover plate, the first movable cover plate and the second movable cover plate are hinged by means of a pin shaft; an anti-inversion block is provided directly below the pin shaft, the anti-inversion block being connected to the first movable cover plate by means of the pin shaft.

Preferentially, a guide wheel is provided below the end of the second movable cover plate away from the first movable cover plate.

Preferentially, an inverting arm is provided below the first movable cover plate, one end of the inverting arm is connected to the anti-inversion block by means of a bearing, the other end is connected to a powered push rod by means of the pin shaft and an oil-containing bearing, and the powered push rod is installed on a powered push rod mounting seat.

Preferentially, the powered push rod mounting seat is connected with the first movable cover plate.

Beneficial effect of the invention: the invention adopts a segmented structure, after the lift unit stretches out, the first movable cover plate returns to the horizontal position, the second movable cover plate leans against the lift pillar and touches with the lift pillar by means of the guide wheel. Compared with the existing inverting cover plate, the invention has the advantages as below: (1) in the process of examination and repair, lifting or descending of the lift unit is no need to open the inverting cover plate, which is convenient for use; (2) the first movable cover plate closed does not take up finite space for examination and repair, and reduces potential safety hazard for maintainers; (3) the vehicle body lift unit applicable for many types is also applicable to the invention no matter whether the propping head is parallel and level to the lift pillar.

### BRIEF DESCRIPTION OF THE DRAWINGS

FIG. 1 is a structure diagram of the invention.

FIG. 2 is a structural drawing of the working state of the invention.

FIG. 3 is a structural drawing of the conventional inverting cover plate 1 at the working state.

FIG. 4 is a structural drawing of the conventional inverting cover plate 2 at the working state.

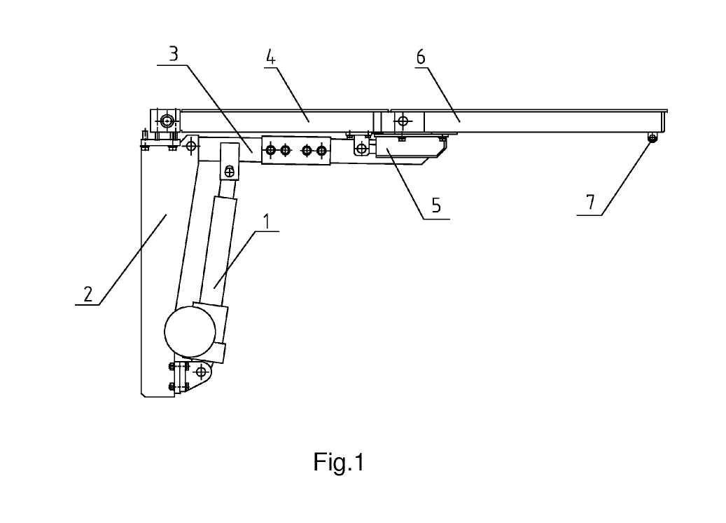

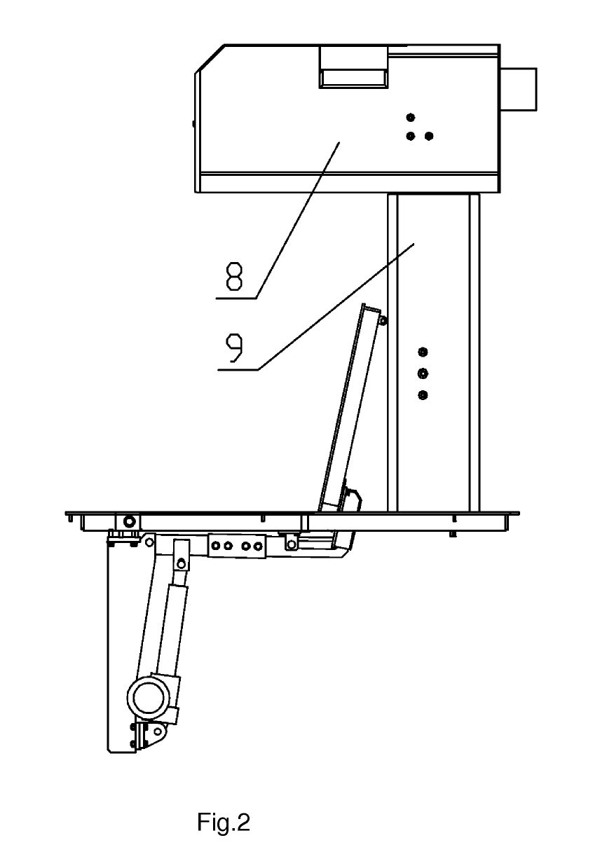

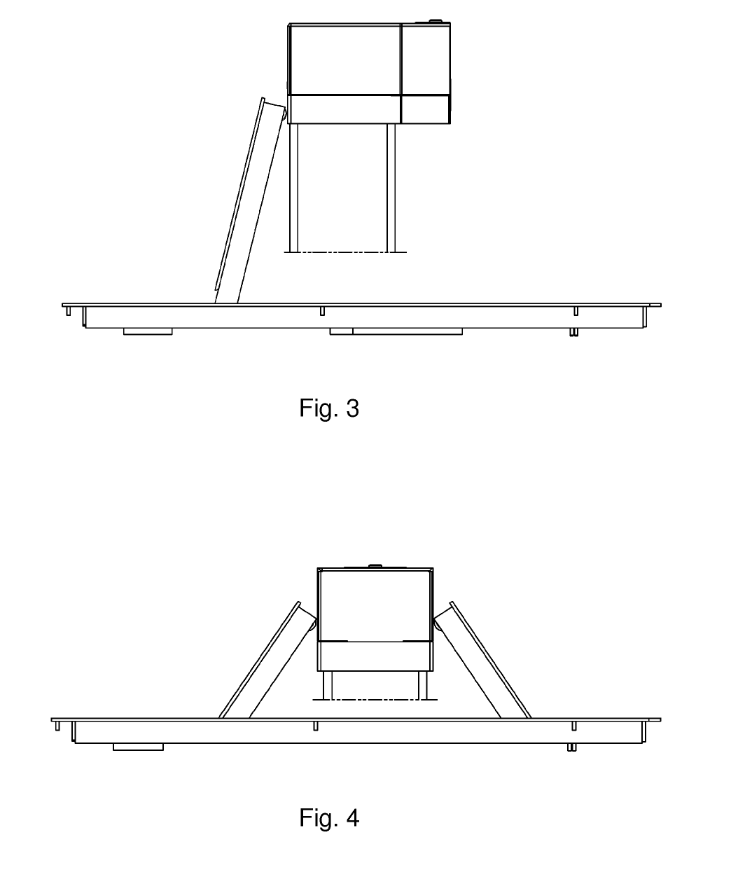

### DETAILED DESCRIPTION OF THE EMBODIMENTS

Further description of the invention is made in combination with the accompanying drawings.

A segmented inverting cover plate apparatus for an underfloor vehicle lifting jack, comprising a cover plate, wherein the cover plate being of a segmented structure, comprising a first movable cover plate 4 and a second movable cover plate 6, the first movable cover plate 4 and the second movable cover plate 6 are hinged by means of a pin shaft; and a guide wheel 7 is provided below the end of the second movable cover plate 6 away from the first movable cover plate 4. An anti-inversion block 5 is provided directly below the pin shaft, the anti-inversion block 5 being connected to the first movable cover plate 4 by means of the pin shaft. An inverting arm 3 is provided below the first movable cover plate 4, one end of the inverting arm 3 is connected to the anti-inversion block 5 by means of a bearing, the other end is connected to a powered push rod 1 by means of the pin shaft and an oil-containing bearing, and the powered push rod 1 is installed on a powered push rod mounting seat 2. The powered push rod mounting seat 2 is connected with the first movable cover plate 4.

The working principle of the segmented inverting cover plate apparatus for an underfloor vehicle lifting jack: at off-working state, the inverting cover plate is at the level condition.

When the propping head 8 and the lift pillar 9 of the vehicle body lift unit elevate above the soil, the inverting cover plate begins working: (1) driven by the powered push rod 1, the inverting arm 3 drives the first movable cover plate 4 and the second movable cover plate 6 to move until inverting nearly 90 degrees; (2) the propping head 8 and the lift pillar 9 of the vehicle body lift unit stretch out; (3) the powered push rod 1 drives the inverting arm 3 to retract, the guide wheel 7 on the inverting cover plate touches with lift pillar 9, the first movable cover plate 4 returns to the horizontal position, and the second movable cover plate 6 leans against the lift pillar 9.

1. A segmented inverting cover plate apparatus for an underfloor vehicle lifting jack, comprising a cover plate, wherein the cover plate being of a segmented structure, comprising a first movable cover plate (4) and a second movable cover plate (6), the first movable cover plate (4) and the second movable cover plate (6) are hinged by means of a pin shaft; an anti-inversion block (5) is provided directly below the pin shaft, the anti-inversion block (5) being connected to the first movable cover plate (4) by means of the pin shaft.

2. The segmented inverting cover plate apparatus for an underfloor vehicle lifting jack according to claim 1, wherein a guide wheel (7) is provided below the end of the second movable cover plate (6) away from the first movable cover plate (4).

3. The segmented inverting cover plate apparatus for an underfloor vehicle lifting jack according to claim 1, wherein an inverting arm (3) is provided below the first movable cover plate (4), one end of the inverting arm (3) is connected to the anti-inversion block (5) by means of a bearing, the other end is connected to a powered push rod (1) by means of the pin shaft and an oil-containing bearing, and the powered push rod (1) is installed on a powered push rod mounting seat (2).

4. The segmented inverting cover plate apparatus for an underfloor vehicle lifting jack according to claim 3, wherein the powered push rod mounting seat (2) is connected with the first movable cover plate (4).

5. The segmented inverting cover plate apparatus for an underfloor vehicle lifting jack according to claim 2, wherein an inverting arm (3) is provided below the first movable cover plate (4), one end of the inverting arm (3) is connected to the anti-inversion block (5) by means of a bearing, the other end is connected to a powered push rod (1) by means of the pin shaft and an oil-containing bearing, and the powered push rod (1) is installed on a powered push rod mounting seat (2).
